(19) United States
(12) Patent Application Publication
(10) Pub. No.: US 2016/0282799 A1
(43) Pub. Date: Sep. 29, 2016

(54) IMAGE FORMING APPARATUS

(71) Applicant: FUJI XEROX CO., LTD., Tokyo (JP)

(72) Inventors: Kunihiko SATO, Kanagawa (JP); Kosuke YAMADA, Kanagawa (JP); Masayo HIGASHIMURA, Kanagawa (JP); Kazunori NUMAO, Kanagawa (JP)

(73) Assignee: FUJI XEROX CO., LTD., Tokyo (JP)

(21) Appl. No.: 14/837,337

(22) Filed: Aug. 27, 2015

(30) Foreign Application Priority Data
Mar. 24, 2015 (JP) 2015-061725

(51) Int. Cl. G03G 15/00

(52) U.S. Cl. CPC G03G 21/00

(57) ABSTRACT

An image forming apparatus includes an image carrier, a transfer unit that transfers a toner image on the image carrier to a continuous medium including an intermediate layer that is an adhesive layer, a fixing unit that fixes the toner image transferred to the medium, a supply unit that is disposed upstream of the transfer unit in a direction in which the medium is transported and that supplies an anti-adhesive agent to an end portion of the medium in a width direction of the medium, a removing unit that is disposed downstream of the fixing unit and that removes the anti-adhesive agent from the medium, and a pasting unit that is disposed downstream of the removing unit and that pastes a protection member to a surface of the medium.

### CROSS-REFERENCE TO RELATED APPLICATIONS

This application is based on and claims priority under 35 USC 119 from Japanese Patent Application No. 2015-061725 filed Mar. 24, 2015.

### BACKGROUND

### Technical Field

The present invention relates to an image forming apparatus.

### SUMMARY

According to an aspect of the present invention, an image forming apparatus includes an image carrier, a transfer unit that transfers a toner image on the image carrier to a continuous medium including an intermediate layer that is an adhesive layer, a fixing unit that fixes the toner image transferred to the medium, a supply unit that is disposed upstream of the transfer unit in a direction in which the medium is transported and that supplies an anti-adhesive agent to an end portion of the medium in a width direction of the medium, a removing unit that is disposed downstream of the fixing unit and that removes the anti-adhesive agent from the medium, and a pasting unit that is disposed downstream of the removing unit and that pastes a protection member to a surface of the medium.

### BRIEF DESCRIPTION OF THE DRAWINGS

Exemplary embodiments of the present invention will be described in detail based on the following figures, wherein:

FIG. 1 illustrates the entirety of an image forming apparatus according to a first exemplary embodiment;

FIG. 2 illustrates a part of the image forming apparatus according to the first exemplary embodiment;

FIG. 3 illustrates a continuous sheet according to the first exemplary embodiment;

FIGS. 4A and 4B illustrate powder supply devices according to the first exemplary embodiment, FIG. 4A showing the positions of the powder supply devices in the width direction of the continuous sheet, and FIG. 4B showing a part of one of the powder supply devices;

FIG. 5 illustrates a post-processing device according to the first exemplary embodiment;

FIG. 6 illustrates a cutting device according to the first exemplary embodiment;

FIG. 7 illustrates a removing unit according to a second exemplary embodiment;

FIG. 8 illustrates a modification of the second exemplary embodiment; and

FIG. 9 illustrates a modification of the second exemplary embodiment.

### DETAILED DESCRIPTION

Hereinafter, exemplary embodiments of the present invention will be described with reference to the drawings. The present invention is not limited to the exemplary embodiments described below.

To facilitate understanding the following description, the directions in the figures are defined as follows: the front-back direction is the X-axis direction, the left-right direction is the Y-axis direction, and the up-down direction is the Z-axis direction. The directions indicated by arrows X, -X, Y, -Y, Z, and -Z are respectively called forward, backward, rightward, leftward, upward, and downward; or the front side, the back side, the right side, the left side, the upper side, and the lower side.

In each of the figures, a symbol “◯” with “·” in it represents an arrow extending from the back side toward the front side of the plane of the figure, and a symbol “◯” with “×” in it represents an arrow extending from the front side toward the back side of the plane of the figure.

In the following descriptions using the figures, members that are not necessary for understanding the descriptions are omitted.

### First Embodiment

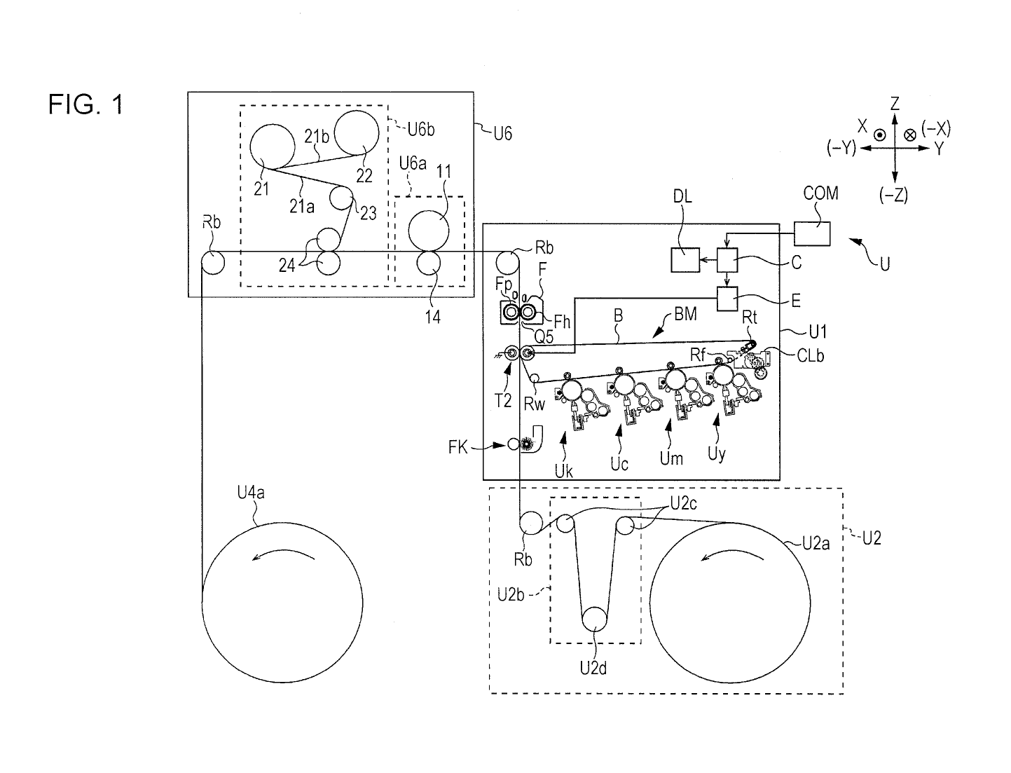

FIG. 1 illustrates the entirety of an image forming apparatus according to the first exemplary embodiment.

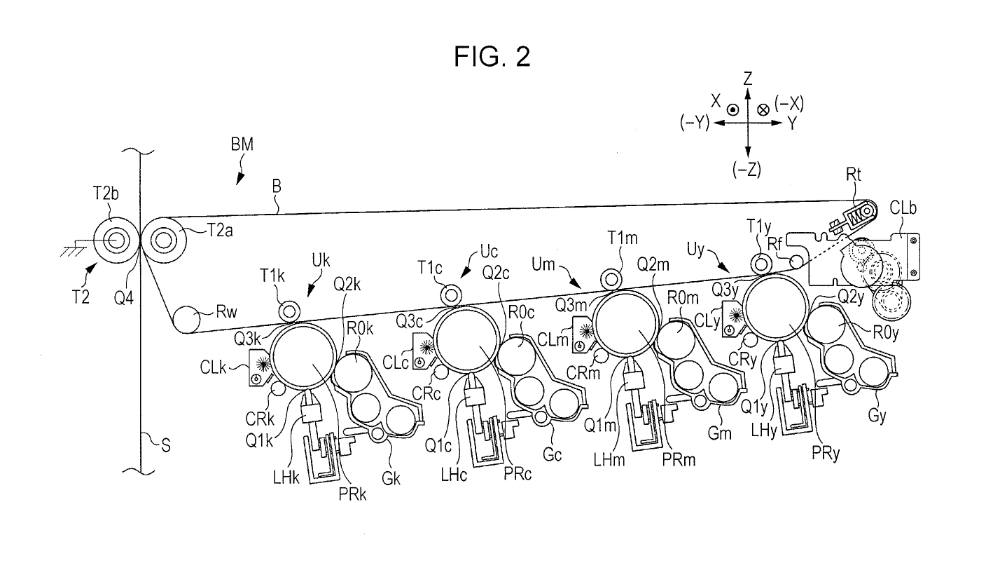

FIG. 2 illustrates a part of the image forming apparatus according to the first exemplary embodiment.

Referring to FIG. 1, a printer U, which is an example of an image forming apparatus according to a first exemplary embodiment of the present invention, includes a printer body U1, which is an example of a recording unit and an example of an image forming unit. The printer body U1 includes a controller C that controls the printer U. The controller C is electrically connected to a personal computer COM, which is an example of an information transmitting device. The controller C is capable of processing image information transmitted from the personal computer COM. The controller C is electrically connected to a writing circuit DL of the printer body U1. The writing circuit DL is electrically connected to LED heads LHy, LHm, LHc, and LHk, each of which is an example of a latent image forming device and an example of an exposure device.

The LED heads LHy, LHm, LHc, and LHk according to the first exemplary embodiment are arranged so as to correspond to yellow(Y), magenta (M), cyan (C), and black (K). Each of the LED heads LHy to LHk according to the first exemplary embodiment is an LED array, in which LEDs, each of which is an example of a light-emitting element, are linearly arranged in the width direction of an image. The LEDs of each of the LED heads LHy to LHk are capable of emitting light in accordance with an input signal. In other words, each of the LED heads LHy to LHk is capable of emitting a writing beam in accordance with an input signal.

Referring to FIG. 1, photoconductors PRy, PRm, PRc, and PRk are respectively disposed above the LED heads LHy to LHk. The photoconductors PRy to PRk respectively face the LED heads LHy to LHk in writing regions Q1y, Q1m, Q1c, and Q1k.

Charging rollers CRy, CRm, CRc, and CRk, each of which is an example of a charger, are respectively disposed upstream of the LED heads LHy to LHk in the direction in which the photoconductors PRy, PRm, PRc, and PRk rotate. The charging rollers CRy to CRk according to the first exemplary embodiment are supported so as to be rotatable while being in contact with the photoconductors PRy to PRk.

Developing device Gy, Gm, Gc, and Gk are respectively disposed downstream of the LED heads LHy to LHk with respect to the direction in which the photoconductors PRy to PRk rotate. The photoconductors PRy to PRk respectively face the developing devices Gy to Gk in development regions Q2y, Q2m, Q2c, and Q2k.

First-transfer rollers T1y, T1m, T1c, and T1k, each of which is an example of a first-transfer unit, are respectively disposed downstream of the developing devices Gy to Gk with respect to the direction in which the photoconductors PRy to PRk rotate. The photoconductors PRy to PRk respectively face the first-transfer rollers T1y to T1k in first-transfer regions Q3y, Q3m, Q3c, and Q3k.

Photoconductor cleaners CLy, CLm, CLc, and CLk, each of which is an example of an image carrier cleaner, are respectively disposed downstream of the first-transfer rollers T1y to T1k with respect to the direction in which the photoconductors PRy to PRk rotate.

The photoconductor PRy, the charging roller CRy, the LED head LHy, the developing device Gy, the first-transfer roller T1y, and the photoconductor cleaner CLy for yellow (Y) constitute an image-forming unit Uy for yellow (Y) according to the first exemplary embodiment. The image-forming unit Uy, which is an example of a visible image forming device for yellow (Y) according to the first exemplary embodiment, forms a toner image, which is an example of a visible image. Likewise, the photoconductors PRm, PRc, and PRk; the charging rollers CRm, CRc, and CRk; the LED heads LHm, LHc, and LHk; the developing devices Gm, Gc, and Gk; the first-transfer rollers T1m, T1c, and T1k; and the photoconductor cleaners CLm, CLc, and CLk respectively constitute image-forming units Um, Uc, and Uk for magenta (M), cyan (C), and black (K).

A belt module BM, which is an example of an intermediate transfer device, is disposed above the photoconductors PRy to PRk. The belt module BM includes an intermediate transfer belt B, which is an example of an image carrier and an example of an intermediate transfer body. The intermediate transfer belt B is an endless-belt-like member.

The intermediate transfer belt B according to the first exemplary embodiment is rotatably supported by a tension roller Rt, which is an example of a tension member; a walking roller Rw, which is an example of a deviation correcting member; an idler roller Rf, which is an example of a driven member; a backup roller T2a, which is an example of a second-transfer-region facing member and an example of a drive member; and the first-transfer rollers T1y, T1m, T1c, and T1k.

A second-transfer roller T2b, which is an example of a second-transfer member, is disposed so as to face a backup roller T2a with the intermediate transfer belt B therebetween. In the first exemplary embodiment, a power circuit E applies a second-transfer voltage, which has a polarity the same as that of the charge of toner, to the backup roller T2a; and the second-transfer roller T2b is grounded. The backup roller T2a and the second-transfer roller T2b constitute a second-transfer unit T2 according to the first exemplary embodiment. The second-transfer roller T2b is in contact with the intermediate transfer belt B in a second-transfer region Q4.

A belt cleaner CLb, which is an example of an intermediate transfer body cleaner, is disposed downstream of the second-transfer region Q4 with respect to the direction in which the intermediate transfer belt B rotates.

The first-transfer rollers T1y to T1k, the intermediate transfer belt B, the second-transfer unit T2, and the like constitute a transfer device T1+T2+B according to the first exemplary embodiment, which is an example of a transfer unit.

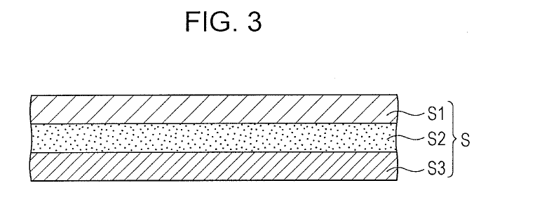

FIG. 3 illustrates a continuous sheet according to the first exemplary embodiment.

Referring to FIG. 1, a sheet feeding device U2, which is an example of a sheet feeding unit, is disposed below the image-forming units Uy to Uk. The sheet feeding device U2 includes a sheet feeding member U2a around which a continuous sheet S, which is an example of a continuous medium, is wound. Referring to FIG. 3, the continuous sheet S according to the first exemplary embodiment is a so-called rolled label sheet, which includes a base sheet S1 having a front surface on which an image is to be printed, an adhesive S2 applied to a back surface of the base sheet S1, and a release sheet S3 to which an adhesive S2 is applied. In other words, the continuous sheet S according to the first exemplary embodiment includes an intermediate layer, which is a layer of the adhesive S2 and which is an example of an adhesive layer.

The sheet feeding member U2a is rotatably supported. A tension application unit U2b, which is an example of a tension application device, is disposed on the left side of the sheet feeding member U2a. The tension application unit U2b includes two driven rollers U2c, each of which is an example of a support member and which support the continuous sheet S. A tension roller U2d, which is an example of a tension application member, is disposed between the driven rollers U2c. The tension roller U2d is supported so as to be movable in the up-down directions while being in contact with the continuous sheet S. The tension roller U2d applies a tension to the continuous sheet S by pushing the continuous sheet S downward with a gravitational force, thereby preventing the continuous sheet S from becoming creased.

The continuous sheet S extends from the sheet feeding device U2 toward the second-transfer region Q4 of the printer body U1. Powder supply devices Fk, each of which is an example of an anti-adhesive agent supply unit, are disposed upstream of the second-transfer region Q4 with respect to the direction in which the continuous sheet S is transported.

A fixing device F, which is an example of a fixing unit, is disposed downstream of the second-transfer roller T2b with respect to the direction in which the continuous sheet S is transported. The fixing device F includes a heating roller Fh, which is an example of a heating member, and a pressing roller Fp, which is an example of a pressing member. A heater, which is an example of a heat source, is disposed in the heating roller Fh.

A guide roller Rb, which is an example of a guide member, is rotatably supported at a position downstream of the fixing device F.

A post-processing device U6 is disposed downstream of the guide roller Rb. The post-processing device U6 includes a cutting device U6a, which is an example of a removing unit. The cutting device U6a cuts off end portions of the continuous sheet S in the width direction.

A lamination device U6b, which is an example of a pasting unit, is disposed downstream of the cutting device U6a. The lamination device U6b pastes a laminate member, which is an example of a protection member, to a surface of the continuous sheet S.

A guide roller Rb, which is an example of a guide member, is disposed downstream of the post-processing device U6.

A winding roller U4a, which is an example of a recovery member, is disposed downstream of the guide roller Rb. The continuous sheet S is wound around the winding roller U4a. The winding roller U4a is driven by a motor (not shown), which is an example of a driving source.

### Description of Image Forming Operation

The printer U according to the first exemplary embodiment, having the structure described above, starts a printing operation when receiving image information from the personal computer COM. On the basis of the received image information, the controller C generates image information for forming latent images for yellow (Y), magenta (M), cyan (C), and black (K). The controller C outputs the generated image information to the writing circuit DL of the printer body U1. If the image is a monochrome image, the controller C outputs image information for only black (K) to the writing circuit DL.

The writing circuit DL outputs control signals to the LED heads LHy to LHk in accordance with input image information. The LED heads LHy to LHk emit laser beams in accordance with the control signals.

The photoconductors PRy to PRk rotate when an image forming operation is started. The power circuit E applies a charging voltage to the charging rollers CRy to CRk. Accordingly, the charging rollers CRy to CRk charge the surfaces of the photoconductors PRy to PRk. The LED heads LHy to LHk emit writing beams to form electrostatic latent images on the surfaces of the charged photoconductors PRy to PRk in the writing regions Q1y to Q1k. The developing devices Gy, Gm, Gc, and Gk develop the electrostatic latent images on the photoconductors PRy to PRk in the development regions Q2y to Q2k so as to form toner images, each of which is an example of a visible image.

The developed toner images are transported to the first-transfer regions Q3y, Q3m, Q3c, and Q3k, in which the first-transfer rollers T1y to T1k contact the intermediate transfer belt B. The power circuit E applies a first-transfer voltage, having a polarity opposite to that of the charge of toner, to the first-transfer rollers T1y to T1k in the first-transfer regions Q3y, Q3m, Q3c, and Q3k. Accordingly, the first-transfer rollers T1y to T1k transfer the toner images on the photoconductors PRy to PRk to the intermediate transfer belt B. In the case of forming a multi-color image, on one of toner images transferred by one of the first-transfer units at an upstream position, another toner image is superposed by another first-transfer unit at a downstream position.

The photoconductor cleaners CLy to CLk clean the photoconductors PRy to PRk by removing substances remaining on and adhering to the photoconductors PRy to PRk after first-transfer. The charging rollers CRy to CRk charge the surfaces of the cleaned photoconductors PRy to PRk again.

The monochrome or multi-color toner image, which has been transferred to the intermediate transfer belt B by the first-transfer rollers T1y to T1k in the first-transfer regions Q3y to Q3k, is transported to the second-transfer region Q4.

The continuous sheet S is transported downstream by receiving transport forces in the second-transfer region Q4 and from the fixing device F and the winding roller U4a.

The powder supply devices Fk prevent the adhesive S2 from adhering to members inside of the printer U by applying powder to both end portions of the continuous sheet S in the width direction at positions upstream of the second-transfer region Q4.

The power circuit E applies a second-transfer voltage, which has a polarity the same as that of the charge of toner, to the backup roller T2a. Accordingly, the toner image on the intermediate transfer belt B is transferred to the continuous sheet S while the continuous sheet S passes through the second-transfer region Q4.

The belt cleaner CLb cleans the surface of the intermediate transfer belt B after second-transfer by removing adhering substances and the like from the surface.

While the continuous sheet S, on which the toner image has been second-transferred, passes through the fixing region Q5, the toner image is thermally fixed to the continuous sheet S.

The continuous sheet S, to which the image has been fixed, is transported to the post-processing device U6. In the post-processing device U6, the cutting device U6a cuts off the end portions of the continuous sheet S in the width direction. Thus, the end portions, to which powder adheres, are removed from the continuous sheet S. After passing through the cutting device U6a, the continuous sheet S is transported to the lamination device U6b. The lamination device U6b pastes a laminate member to the surface of the continuous sheet S.

After passing through the post-processing device U6, the continuous sheet S is wound around the winding roller U4a.

### Description of Powder Supply Device Fk

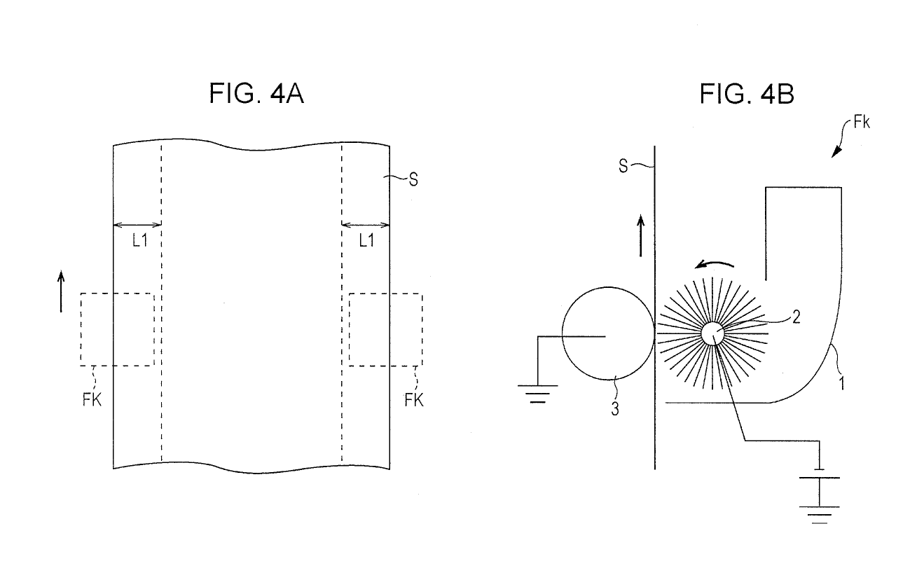

FIGS. 4A and 4B illustrate the powder supply devices according to the first exemplary embodiment, FIG. 4A showing the positions of the powder supply devices in the width direction of the continuous sheet, and FIG. 4B showing a part of one of the powder supply devices.

Referring to FIG. 4A, the powder supply devices Fk according to the first exemplary embodiment are disposed at both ends of the continuous sheet S in the width direction. Referring to FIG. 4B, each of the powder supply devices Fk according to the first exemplary embodiment includes a containing portion 1 for containing powder, which is an example of an anti-adhesive agent. A rotary brush 2, which is an example of a supply member, is supported by the containing portion 1. The rotary brush 2 is a cylindrical brush having multiple electroconductive bristles. The rotary brush 2 is rotated by a driving source (not shown). A rotary roller 3, which is an example of a support member, is rotatably supported so as to face the rotary brush 2 with the continuous sheet S therebetween.

A voltage having a polarity opposite to that of the charge of the powder is applied to the rotary brush 2. Examples of the material of the powder that is usable in the first exemplary embodiment include toners, such as a transparent toner and a white toner; inorganic materials, such as silica; lubricants, such as zinc stearate (ZnSt) and polytetrafluoroethylene (PTFE); and abrasives, such as cerium oxide included in a developing agent.

Accordingly, the powder supply devices Fk according to the first exemplary embodiment supply the powder to adhesion regions L1 at the left and right end portions of the continuous sheet S.

### Description of Post-processing Device U6

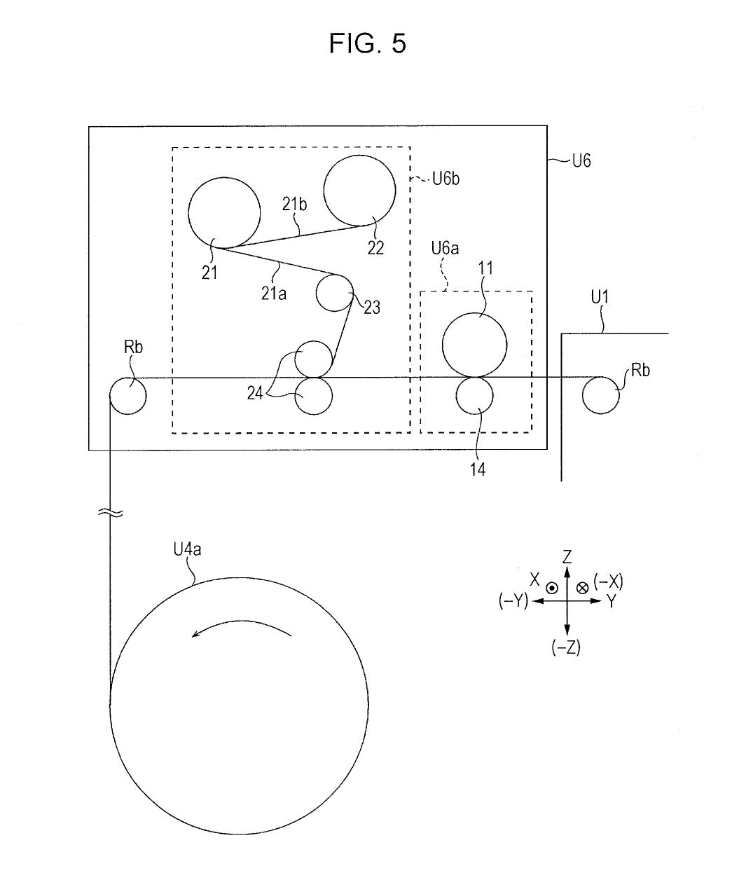

FIG. 5 illustrates the post-processing device according to the first exemplary embodiment.

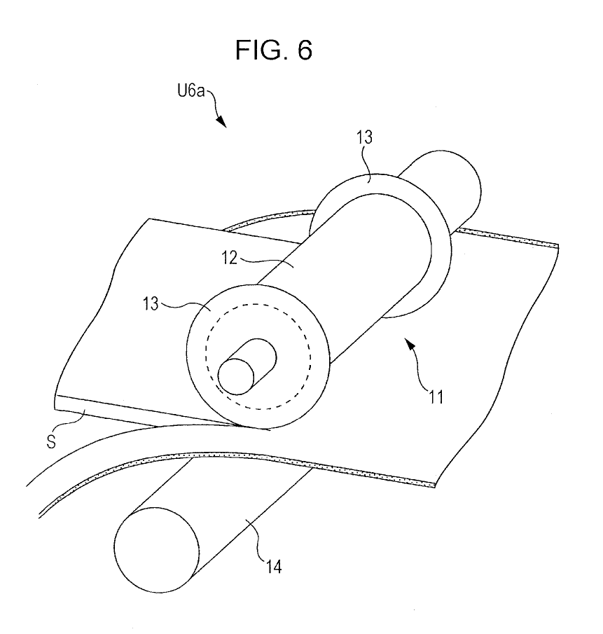

FIG. 6 illustrates the cutting device according to the first exemplary embodiment.

Referring to FIGS. 5 and 6, the cutting device U6a of the post-processing device U6 according to the first exemplary embodiment includes a rotary cutter 11, which is an example of a cutting member. The rotary cutter 11 rotates by being driven by a motor (not shown), which is an example of a driving source. Referring to FIG. 6, the rotary cutter 11 includes a roller unit 12, which is an example of a transport unit, extending in the width direction of the continuous sheet S. The roller unit 12 contacts a surface of the continuous sheet S.

Cutter bodies 13, each of which is an example of a cutting member body, are supported at both ends of the roller unit 12. Each cutter body 13 has a disk-like shape and has a blade, for cutting the continuous sheet S, around the perimeter thereof. The radius of each cutter body 13 is larger than that of the roller unit 12 by the thickness of the continuous sheet S. The cutter bodies 13 are disposed at predetermined positions inward from the adhesion regions L1, to which the powder supply devices Fk supply the powder.

Referring to FIG. 6, a rotary roller 14, which is an example of a support member, is disposed so as to face the rotary cutter 11 with the continuous sheet S therebetween. The rotary roller 14 rotates while being in contact with the lower surface of the continuous sheet S.

The lamination device U6b includes a laminate supply roller 21 around which a laminate member 21a, which is an example of a protection member and which is to be pasted to the surface of the continuous sheet S, is wound. The laminate member 21a, to which an adhesive used to paste the laminate member 21a to the continuous sheet S has been applied and to which a release sheet 21b has been pasted, is wound around the laminate supply roller 21. A first scrap removing roller 22, which is an example of a winding member, for winding the release sheet 21b is disposed on the right side of the laminate supply roller 21. The first scrap removing roller 22 is driven by a motor (not shown), which is an example of a driving source.

A guide roller 23, which is an example of a guide member, is disposed below the laminate supply roller 21. The guide roller 23 guides the laminate member 21a, from which the release sheet 21b has been peeled off.

A pasting roller 24, which is an example of a pasting member, is disposed below the guide roller 23. The pasting roller 24 is driven by a motor (not shown), which is an example of a driving source. The pasting roller 24 transports the continuous sheet S and the laminate member 21a downstream while nipping and pasting the continuous sheet S and the laminate member 21a together.

The printer U according to the first exemplary embodiment, having the structure described above, uses the continuous sheet S, which is a label sheet having the adhesive S2. If the powder supply devices Fk were not provided, when the continuous sheet S is nipped in the second-transfer region Q4 or the fixing region Q5, the adhesive S2 might be squeezed out of the end portions in the width direction and might adhere to the intermediate transfer belt B, the fixing device F, or the like. In contrast, with the first exemplary embodiment, the powder supply devices Fk apply powder to the end portions of the continuous sheet S so that the powder covers the surface of the adhesive S2, thereby preventing the adhesive S2 from directly adhering to the inside of the printer U even if the adhesive S2 is squeezed out of the end portions.

However, when pasting the laminate member 21a to the continuous sheet S to which the powder has been applied, the powder on the surface of the continuous sheet S might generate bubbles while the laminate member 21a is being pasted. In other words, defective lamination might occur.

To prevent this, in the first exemplary embodiment, the cutting device U6a, which is an example of a removing unit, is disposed downstream of the fixing device F and upstream of the lamination device U6b. The cutting device U6a removes the powder from the continuous sheet S by cutting off portions of the continuous sheet S to which the powder adheres. Thus, occurrence of defective lamination when the lamination device U6b pastes the laminate member 21a is reduced.

In the cutting device according to the first exemplary embodiment U6a, the rotary cutter 11 is used as a cutting member. However, this is not a limitation. For example, a cutting member that does not rotate, such as a fixed knife-shaped cutting member, may be used.

### Second Embodiment

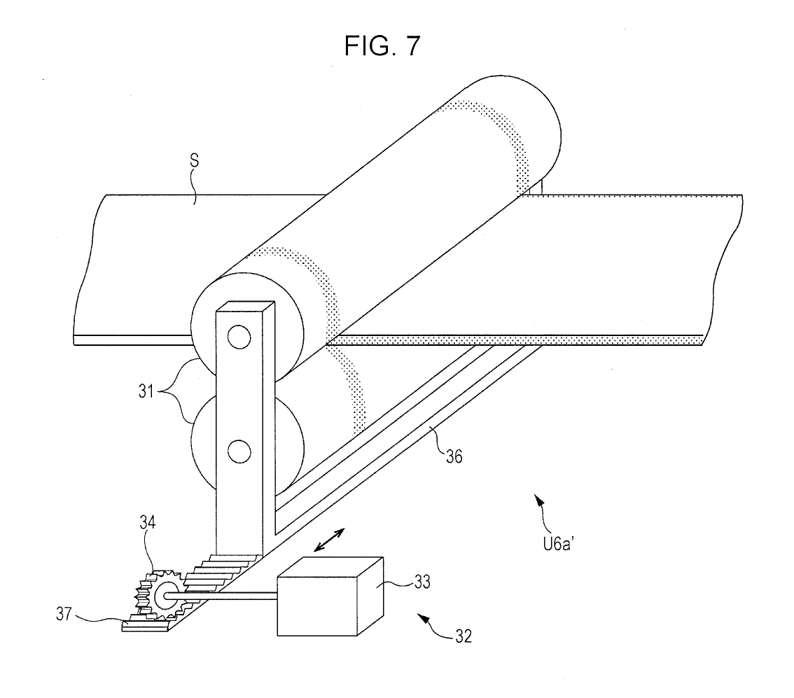

FIG. 7 illustrates a removing unit according to a second exemplary embodiment.

In the following description according to the second exemplary embodiment according to the present invention, elements of the second exemplary embodiment corresponding to those of the first exemplary embodiment will be denoted by the same numerals and detailed description of such elements will be omitted.

The second exemplary embodiment differs from the first exemplary embodiment in the following respects, but is the same as the first exemplary embodiment in other respects.

Referring to FIG. 7, a printer U according to the second exemplary embodiment includes a cleaning device U6a′, which is an example of a removing unit, instead of the cutting device U6a of the first exemplary embodiment. The cleaning device U6a′ according to the second exemplary embodiment includes a pair of cleaning rollers 31, which are an example of a cleaning member. The cleaning rollers 31 face each other with the continuous sheet S therebetween. The cleaning rollers 31 according to the second exemplary embodiment are made of a silicon rubber having an adhesive surface.

The cleaning rollers 31 according to the second exemplary embodiment are supported by a driving mechanism 32 so as to be movable in the width direction of the continuous sheet S. The driving mechanism 32 includes a motor 33, which is an example of a driving source. A gear 34, which is an example of a gear, is supported by the rotation shaft of the motor 33. The gear 34 meshes with a rack 37, which is an example of a plate-shaped gear, extending from a frame 36 that supports the cleaning rollers 31. Thus, as the motor 33 is driven, the gear 34 and the rack 37 function to move the cleaning rollers 31 in the width direction of the continuous sheet S. In the second exemplary embodiment, a predetermined period is determined beforehand on the basis of a period during which the surface of the cleaning rollers 31 becomes smeared with the powder; and every time the predetermined period elapses, the motor 33 moves the cleaning rollers 31 forward so that parts of the cleaning rollers 31 that have not been smeared with the powder are moved to the end portions of the continuous sheet S. Operational Effects of Second Exemplary Embodiment

With the printer U according to the second exemplary embodiment having the structure described above, the powder supplied to the end portions of the continuous sheet S in the width direction is removed by the cleaning rollers 31 at a position upstream of the lamination device U6b.

Accordingly, the powder has been removed from the continuous sheet S before lamination is performed, and therefore occurrence of defective lamination is reduced. Moreover, with the second exemplary embodiment, when the surface of the cleaning rollers 31 becomes smeared with the removed powder, the cleaning roller 31 is moved in the width direction, so that parts of the surface that have not been smeared are moved to both end portions of the continuous sheet S. Thus, it is possible to maintain the performance of the cleaning rollers 31 for a long time.

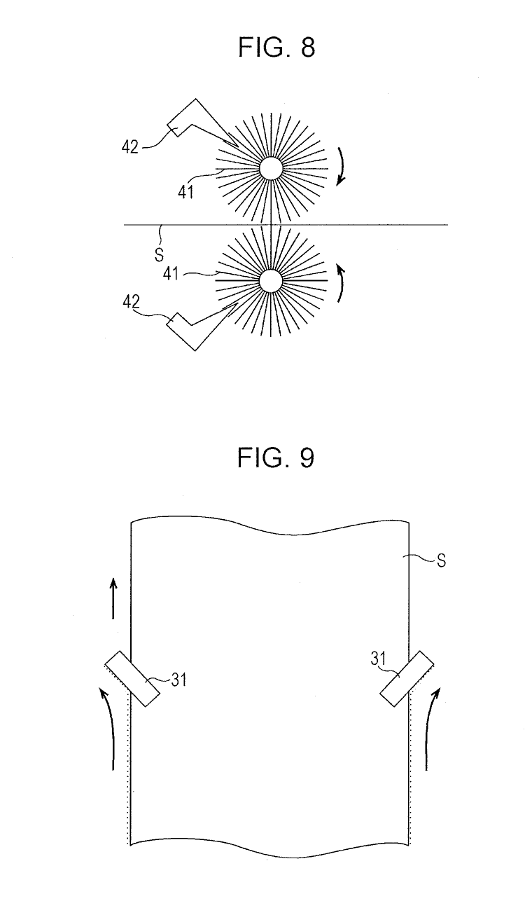

FIG. 8 illustrates a modification of the second exemplary embodiment.

In the second exemplary embodiment, each cleaning roller 31 is made of an adhesive silicone rubber. However, this is not a limitation. Alternatively, for example, a roller having a surface to which an adhesive has been applied may be used. Further alternatively, the powder may be removed by using a non-adhesive member. For example, as illustrated in FIG. 8, a brush roller 41a, which is a brush-like member having plural bristles and which is an example of a cleaning member, may be used to remove the powder from the continuous sheet S. At this time, a flicker 42, which is an example of a removing member, may be made to contact the brush roller 41, so that the powder collected by the brush roller 41 is flicked off the brush roller 41 and the cleaning performance is maintained for a long time.

Instead of an adhesive material or a brush that physically removes the powder, a porous body, which is a so-called sponge, may be used to remove the powder by absorbing the powder into multiple holes in the sponge.

In the second exemplary embodiment, roller-like members are used as the cleaning rollers 31. However, this is not a limitation. For example, fixed pad-like members or fixed brush-like members may be used.

FIG. 9 illustrates a modification of the second exemplary embodiment.

As illustrated in FIG. 9, the cleaning rollers 31 is disposed so as to be inclined outward in the width direction with respect to the downward direction in which the continuous sheet S is transported, so that the powder removed by the cleaning rollers 31 flows outward in the width direction.

### Modifications

The present invention is not limited to the exemplary embodiments described above and may be modified in various ways within the spirit and scope of the present invention described in the claims. Examples of modifications (H01) to (H05) of the present invention are as follows.

(H01) In the exemplary embodiments, the printer U is described an example of an image forming apparatus. However, this is not a limitation. The image forming apparatus may be, for example, a copier, a fax, or a multifunctional machine having some or all of the functions a copier and a fax.

(H02) In the exemplary embodiments, the printer U uses developing agents for four colors. However, this is not a limitation. For example, the present invention may be applied to a monochrome image forming apparatus or a multi-color image forming apparatus using developing agents for less than three or five or more colors.

(H03) In the exemplary embodiments, the tension application unit U2b may be provided. However, if it is possible to suppress loosening or creasing of the continuous sheet S by using a different method, the tension application unit U2b may be omitted.

(H04) In the exemplary embodiments, the post-processing device includes only the lamination device U6b. However, this is not a limitation. Any post-processing devices, such as a device for forming a folding line, a device for forming a hole, and a device for cutting a label portion, may be connected.

(H05) In the second exemplary embodiment, it is not necessary that only one of the cleaning rollers 31 having an adhesive surface, the brush roller 41, and the porous roller such as a sponge roller, be used. For example, two or more cleaning members may be arranged in the direction in which the continuous sheet S is transported.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image carrier;
a transfer unit that transfers a toner image on the image carrier to a continuous medium including an intermediate layer that is an adhesive layer;
a fixing unit that fixes the toner image transferred to the medium;
a supply unit that is disposed upstream of the transfer unit in a direction in which the medium is transported and that supplies an anti-adhesive agent to an end portion of the medium in a width direction of the medium;
a removing unit that is disposed downstream of the fixing unit and that removes the anti-adhesive agent from the medium; and
a pasting unit that is disposed downstream of the removing unit and that pastes a protection member to a surface of the medium.

2. The image forming apparatus according to claim 1,
wherein the removing unit includes a cutting member that removes the anti-adhesive agent by cutting off the end portion of the medium.

3. The image forming apparatus according to claim 1,
wherein the removing unit includes a cleaning member that removes the anti-adhesive agent by cleaning the end portion of the medium.

4. The image forming apparatus according to claim 3,
wherein the cleaning member is a brush-like member including a plurality of bristles that contact the end portion of the medium.

5. The image forming apparatus according to claim 3,
wherein the cleaning member is a porous body that contacts the end portion of the medium.

6. The image forming apparatus according to claim 3,
wherein the cleaning member has an adhesive surface that contacts the end portion of the medium.

7. The image forming apparatus according to claim 3,
wherein the cleaning member is a rotary body that rotates as the medium is transported.

8. The image forming apparatus according to claim 4,
wherein the cleaning member is a rotary body that rotates as the medium is transported.

9. The image forming apparatus according to claim 5,
wherein the cleaning member is a rotary body that rotates as the medium is transported.

10. The image forming apparatus according to claim 6,
wherein the cleaning member is a rotary body that rotates as the medium is transported.

11. The image forming apparatus according to claim 3,
wherein the removing unit includes a removing member that removes the anti-adhesive agent, which has been removed from the medium by the cleaning member, from the cleaning member by contacting the cleaning member.

12. The image forming apparatus according to claim 4,
wherein the removing unit includes a removing member that removes the anti-adhesive agent, which has been removed from the medium by the cleaning member, from the cleaning member by contacting the cleaning member.

13. The image forming apparatus according to claim 5,
wherein the removing unit includes a removing member that removes the anti-adhesive agent, which has been removed from the medium by the cleaning member, from the cleaning member by contacting the cleaning member.

14. The image forming apparatus according to claim 6,
wherein the removing unit includes a removing member that removes the anti-adhesive agent, which has been removed from the medium by the cleaning member, from the cleaning member by contacting the cleaning member.

15. The image forming apparatus according to claim 7,
wherein the removing unit includes a removing member that removes the anti-adhesive agent, which has been removed from the medium by the cleaning member, from the cleaning member by contacting the cleaning member.

16. The image forming apparatus according to claim 8,
wherein the removing unit includes a removing member that removes the anti-adhesive agent, which has been removed from the medium by the cleaning member, from the cleaning member by contacting the cleaning member.

17. The image forming apparatus according to claim 9,
wherein the removing unit includes a removing member that removes the anti-adhesive agent, which has been removed from the medium by the cleaning member, from the cleaning member by contacting the cleaning member.

18. The image forming apparatus according to claim 10,
wherein the removing unit includes a removing member that removes the anti-adhesive agent, which has been removed from the medium by the cleaning member, from the cleaning member by contacting the cleaning member.
